(19) United States
(12) Patent Application Publication
(10) Pub. No.: US 2021/0383330 A1
(43) Pub. Date: Dec. 9, 2021

(54) SYSTEM AND METHOD FOR MULTIVARIATE AND MACHINE LEARNING ANALYSIS ON CAREER MANAGEMENT PLATFORMS

(71) Applicants: Robert W. Currie, Cedar Grove, NC (US); Brian John McGuire, Prior Lake, MN (US); Suzanne Elizabeth Whalen, Westwood, NJ (US); Robert Terrell Watterson, Jacksonville, FL (US)

(72) Inventors: Robert W. Currie, Cedar Grove, NC (US); Brian John McGuire, Prior Lake, MN (US); Suzanne Elizabeth Whalen, Westwood, NJ (US); Robert Terrell Watterson, Jacksonville, FL (US)

(21) Appl. No.: 16/896,362

(22) Filed: Jun. 9, 2020

(51) Int. Cl. G06Q 10/10; G06N 7/00; G06N 3/063; G06K 9/62; G06F 3/0482

(52) U.S. Cl. CPC G06Q 10/1053; G06N 7/005; G06F 3/0482; G06K 9/6256; G06N 3/063

(57) ABSTRACT

A system for forecasting a chance of success of a user locating employment, assisting the user to become employed, or both, is disclosed. The system has at least one client device associated with a user, a network interface for receiving an input from the GUI, and sending an output to a server, wherein the output is associated with the at least one task. A machine learning module has a data repository, a monitoring module, a predictive analyzer module and a multivariate analyzing module that utilizes an output confidence metric from the data repository to perform predictive modeling to correlate outputs associated with the at least one task with confidence data to output a quantification of chance of success at finding the employment. A method for forecasting a chance of success of a user locating employment, assisting the user to become employed, or both is provided as well.

### FIELD OF THE INVENTION

The present disclosure relates to multivariate and machine learning for career consulting and management platforms. More particularly, the invention relates to an automated system and method for providing career consulting and management services utilizing advanced routing schemes, multivariate analysis and machine learning.

### BACKGROUND OF THE INVENTION

Finding appropriate employment is amongst the most important and consequential endeavors a person faces in life. However, few people are well versed in how to go about optimizing finding and selecting the best job for them.

If a person is entering the job market for the first time recently, they are not likely to understand how the recruiting process has changed. That puts them at a competitive disadvantage.

Furthermore, if a person suddenly or unexpectedly loses their job, the various common states of emotion (anger, depression, fear, lack of confidence, etc.) will often be a barrier to doing the things most necessary to seize the opportunity to advance their career.

Importantly, if a person is looking for work, they are unlikely to understand how various employment-seeking activities affect the probability of landing an appropriate position.

The career coaching industry caters to helping people looking to transition to new employment. However, their fees can be prohibitive, and many people either don't have the means to afford retaining a career coach, or don't see the value of such an expenditure.

Employment related hardware and software platforms (e.g., matching systems) have issues as well. From a technical standpoint, many are a “one size fits all” model that do not account for the unique desires of people in similarly situated groups. Further, the shear amount of data required to successfully place a candidate bogs down current systems to the point where important data points and information must be left off the system due to sorting issues and the expense of housing this data in a database, a cloud and/or web servers.

Therefore, there is a need for a low cost and efficient means to provide career coaching services to jobseekers via an automated platform that captures and analyzes their personal data to provide individualized, data-driven advice to optimize the jobseeker's prospects of finding and landing a suitable job.

### SUMMARY OF THE INVENTION

To achieve the foregoing and other aspects and in accordance with the purpose of the invention, advanced routing schemes, multivariate analysis and machine learning, together for a virtual system and method for providing career consulting and management services is disclosed.

An objective of the present platform is to provide a new and improved system and method for allowing jobseekers to find potential employment opportunities and secure a new job through the development of personal brand properties, custom resumes and cover letters, and strategic networking campaigns.

Another objective of the present system and method is to provide a self-contained, organized platform within which a jobseeker will gather and create employment-related data, learn the best means of securing employment and manage the process of seeking and securing a new job.

Another objective of the present system and method is to utilize machine learning, data mining technology, data routing and multivariate analysis to increase the efficiency and effectiveness of the of an employment platform and to forecast the chances of employment whilst recommending tertian tasks that increase the likelihood of success.

Another objective of the present system is to combine multivariate analysis with machine learning technology to help jobseekers getting back to work.

The system comprises a client device and a server in communication with the client device via a network. The server comprises a memory to store instructions and a processor coupled with the memory to store the results of various questionnaires, exercises and activities via a webserver, for example. The system further comprises a proxy server operably coupled to the client device and the server to filter requests, improve performance, and share connections to other elements in the system. The system further comprises a task database storing the results of various questionnaires, exercises and activities. The system further comprises a client database storing data related to the user comprising personal information, tasks performed by the user and result of tasks performed by the user.

The system further comprises a virtual server and machine learning and modeling server. The machine learning and modeling server comprises a training module and prediction and scanning module. In one embodiment, the client device, the proxy server, the web server, the platform server, the machine learning and modeling server and the virtual server are connected to one another, either directly or indirectly, via a network. The server is configured to receive user data from the client device associated with the user. The server is further configured to provide one or more activities to be performed by the user and collect result data of the activities performed by the user. The server is further configured to calculate a score that indicates a likelihood of receiving an offer for an employment position, based on the user data and task result data and provide one or more tasks to increase the score. Further, the server allows for manual tuning of the module by a managing user.

In embodiments, the server is further configured to integrate artificial intelligence to learn the types of data that is statistically more relevant and reliable, and parse data based on the model. The server further uses machine learning to provide additional activities to the user for career consulting and management services. The server is further configured to create a weekly point system to measure degree of user's activities to receiving an offer for the employment position and correlate user data and result data with job landing success rate.

In embodiments, a system for forecasting a chance of success of a user locating employment, assisting the user to become employed, or both is provided. The system comprises at least one client device associated with a user, wherein the at least one client device comprises a graphical user interface (GUI) that allows a user to complete at least one task, a network interface for receiving an input from the GUI, and sending an output to a server, wherein the output is associated with the at least one task, a machine learning module residing on the server and in communication with the network, wherein the machine learning module comprises a data repository for collecting the outputs associated with the at least one task and to associate the outputs to the at least one user, a group of users, or both, a monitoring module to monitor user inputs and outputs and update the machine learning module thereby providing a loop, and a predictive analyzer module to analyze which of the at least one tasks correlates with a confidence metric, wherein the confidence metric predicts employment for a user, and further, to output the confidence metric, and a multivariate analyzing module in communication with the machine learning module and the data repository, wherein the multivariate analyzing module utilizes output confidence metric from the data repository to perform predictive modeling to correlate outputs associated with the at least one task with confidence data to output a quantification of chance of success at finding the employment.

In embodiments, a non-transitory computer-readable medium for storing instructions that, when executed on one or more processors, cause the one or more processors to generate, for display on a client device graphical user interface (GUI) associated with at least one user, at least one task to be completed by the user, receive an output from the client device GUI, wherein the output is associated with the at least one task completed by the user, compile, at a data repository, the outputs, generate a confidence metric using a machine learning module, determine which of the at least one tasks correlates with the confidence metric that relates to predicting employment for the user, monitor the user inputs and outputs and update the machine learning module thereby providing a loop, perform multivariate analysis utilizes the output confidence metric and the outputs to perform predictive modeling to correlate monitored data with confidence data and output a quantification of chance of success of the user at finding the employment.

In embodiments, a method for providing career consulting and management services incorporated in a system including a client device, and a server in communication with the client device is provided, wherein the server comprises a memory to store instructions and a processor coupled with the memory to process the stored instructions, the method comprising the steps of generating, for display on a client device graphical user interface (GUI) associated with at least one user, at least one task to be completed by the user, receiving a user output from the client device GUI, wherein the output is associated with the at least one task completed by the user, compiling, at a data repository, the user outputs, generating a confidence metric using a machine learning module, determining which of the at least one tasks correlates with the confidence metric that relates to predicting employment for the user, monitoring the user inputs and outputs and update the machine learning module thereby providing a loop, performing multivariate analysis utilizing the output confidence metric and the compiled user output data to perform predictive modeling to correlate monitored data with confidence data, and outputting a quantification of chance of success of the user at finding the employment.

In one embodiment, a method for routing data through a platform whilst parsing certain data to save on data storage costs and speed up calculations to improve efficacy of the system is provided.

The method comprises providing career consulting and management services incorporated in a system including a client device, and a server in communication with the client device, wherein the server comprises a memory to store instructions and a processor coupled with the memory to process the stored instructions. At one step, the user inputs user data via the client device associated with the user. At another step, one or more tasks are sent to the user and result data of the tasks performed by the user is stored at the memory of the server. At another step, a scope is generated the score that indicates a likelihood of receiving an offer for an employment position is calculated based on the user data and task result data. At another step, one or more tasks are provided to the user to increase the score and increase the probability of landing on the desired employment.

Other features, advantages, and aspects of the present system will become more apparent and be more readily understood from the following detailed description, which should be read in conjunction with the accompanying drawings.

### BRIEF DESCRIPTION OF THE DRAWINGS

The present system is illustrated by way of example, and not by way of limitation, in the figures of the accompanying drawings and in which like reference numerals refer to similar elements and in which:

FIG. 1 is a block diagram showing an environment incorporated with the automated system for providing career consulting and management services, according to an embodiment of the present platform.

FIG. 2 is a block diagram showing components and connections between the components of the automated system for providing career consulting and management services, according to an embodiment of the present platform.

FIG. 3 illustrates a machine learning neural network nodes together with scoring overlay, according to an embodiment of the present platform.

FIG. 4 illustrates a method for providing career consulting and management services, according to an embodiment of the present platform.

FIG. 5 illustrates a screenshot of a user interface of an initial survey to be completed by the user, according to an embodiment of the present platform.

FIG. 6 illustrates a screenshot of a user interface of a survey to be completed by the user to identify suitable employment position, according to an embodiment of the present platform.

FIG. 7 illustrates a screenshot of a user interface displaying one or more activities to be performed by the user, according to an embodiment of the present platform.

FIG. 8 illustrates a screenshot of a user interface displaying exercises that facilitates the user to handle situation on leaving the employer, according to an embodiment of the present platform.

FIG. 9 illustrates a screenshot of a user interface displaying the result of the exercises that facilitate the user to handle the situation on leaving the employer, according to an embodiment of the present platform.

FIG. 10 illustrates a screenshot of a user interface displaying one or more activities to be performed by the user to build a brand to align with the user's ideal job, according to an embodiment of the present platform.

FIG. 11 illustrates a screenshot of a user interface of survey to obtain vision data related to user's career and job search, according to an embodiment of the present platform.

FIG. 12 illustrates a screenshot of a user interface of survey to obtain objective data related to user's career and job search, according to an embodiment of the present platform.

FIG. 13 illustrates a screenshot of a user interface displaying results of survey of FIG. 11 and FIG. 12, according to an embodiment of the present platform.

FIG. 14 illustrates a screenshot of a user interface for constructing a history of your experience, education and other user related information, according to an embodiment of the present platform.

FIG. 15 illustrates a screenshot of a user interface for organizing user's resume to showcase user's key accomplishments, according to an embodiment of the present platform.

FIG. 16 illustrates a screenshot of a user interface displaying target employers log to the user, according to an embodiment of the present platform.

FIG. 17 illustrates a screenshot of a user interface displaying user's complete career journey, according to an embodiment of the present platform.

FIG. 18 illustrates a block diagram showing components and connections between the components of the automated system for providing career consulting and management services, according to an embodiment of the present platform.

### DETAILED DESCRIPTION OF THE PREFERRED EMBODIMENTS

The present system is best understood by reference to the detailed description and examples set forth herein.

Embodiments of the system are discussed below with reference to the examples. However, those skilled in the art will readily appreciate that the detailed description given herein with respect to these examples is for explanatory purposes as the system extends beyond these limited embodiments. For example, it should be appreciated that those skilled in the art will, in light of the teachings of the present system, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the system that are too numerous to be listed but that all fit within the scope of the system. Also, singular words should be read as plural and vice versa and masculine as feminine and vice versa, where appropriate, and alternative embodiments do not necessarily imply that the two are mutually exclusive.

It is to be further understood that the present system is not limited to the particular methodology, compounds, materials, manufacturing techniques, uses, and applications, described herein, as these may vary. It is also to be understood that the terminology used herein is used for the purpose of describing particular embodiments only and is not intended to limit the scope of the present system. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this system belongs. Preferred methods, techniques, devices, and materials are described, although any methods, techniques, devices, or materials similar or equivalent to those described herein may be used in the practice or testing of the present system.

The present system discloses to an automated system and method for providing career consulting and management services utilizing advanced routing schemes, multivariate analysis and machine learning, together.

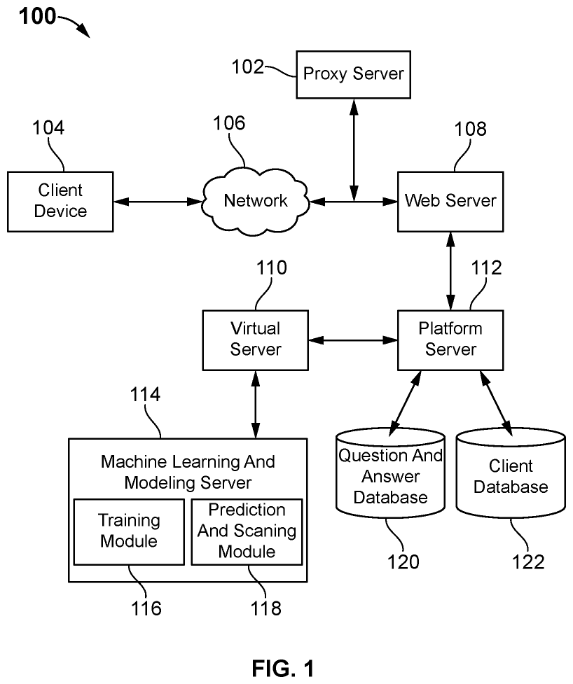

FIG. 1 illustrates a platform 100 in which an advanced routing schemes, multivariate analysis and machine learning is incorporated with an automated system for providing career consulting and management services according to an embodiment of the present platform. The system comprises a client device 104, a proxy server 102, a web server 108, a platform server 112, a machine learning and modeling server 114 and a virtual server 110 connected to one another, either directly or indirectly, via a network 106. In operation, the client device 104 is configured to transmit a request to the web server 108 via the proxy server 102 and receive information from the server 102 and vice versa.

Client device 104 is a computing device from which a user accesses the services provided by the server 108. In one embodiment, the user accessing client device 104 may be an individual or an organization. client device 104 have the capability to communicate over network 106. Client device 104 further has the capability to provide the user an interface to interact with the services provided by the server 108. Client device 104 may be, for example, a desktop computer, a laptop computer, a mobile phone, a personal digital assistant, and the like. In embodiments, the system is integrated into an online mobile application downloadable from an application server or cloud.

Client device 104 may execute one or more client applications such as, without limitation, a web browser to access and view content over a computer network, an email client to send and retrieve emails, a File Transfer Protocol (FTP) client for file transfer. client device 104, in various embodiments, may include a Wireless Application Protocol (WAP) browser or other wireless or mobile device protocol suites.

Network 106 generally represents one or more interconnected networks, over which a proxy server 102, a web server 108, a platform server 112, and virtual server 110, and client device 104 can communicate with each other. Network 106 may comprise packet-based wide area networks (such as the Internet), local area networks (LAN), private networks, wireless networks, satellite networks, cellular networks, paging networks, and the like. A person skilled in the art will recognize that network 106 may also be a combination of more than one type of network 106. For example, network 106 may be a combination of a LAN and the Internet. In addition, network 106 may be implemented as a wired network, or a wireless network or a combination thereof.

The client device 104 is configured to allow the user to complete one or more tasks provided to the user, which includes, but is not limited to, filling questionnaires and answers multiple choice questions that reside on Q&A database 120. The proxy server sits between a client program (typically a Web browser) and an external server (typically another server on the Web) to filter requests, improve performance, and share connections. The web server 108 serves static content to a web browser by loading a file from a disk and serving it across the network to a user's web browser. This entire exchange is mediated by the browser and server talking to each other using HTTP used for Q&A on the Q&A database 120.

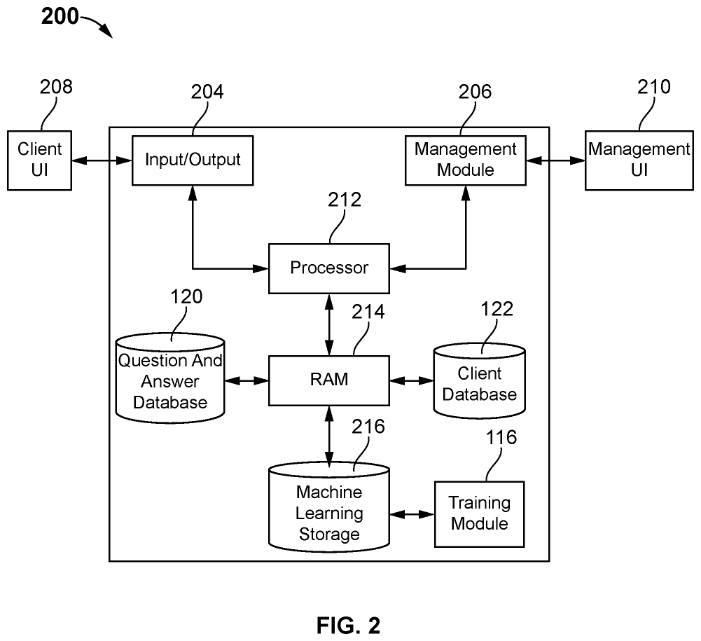

The platform server 112 is the underlying hardware or software for the systems and is thus the engine that drives the web server 108 and communicates with the databases including client database 122 and Q&A database 120. However, the virtual server 110 and machine learning and modeling module 114 and training module 116 are further provided to mediate and parse information that is being shared between the servers and the user device to route the appropriate data to the servers and the user based on certain parameters to be discussed in greater detail in relation to FIGS. 2, 3 and 18.

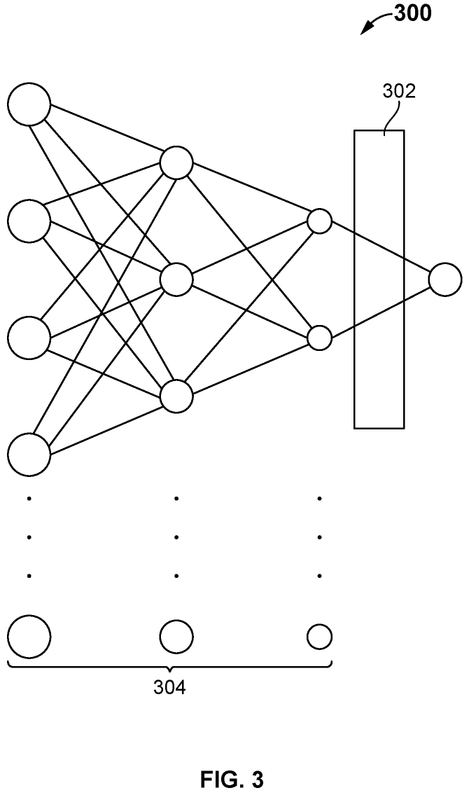

The Q&A database 120 stores questionnaire and multiple-choice questions, and further, user answers to those questions. The client database 122 stores user data comprising tasks or activity performed by the user. The virtual server 110 is run through a data center to speed up calculations and user only certain data that is relevant and most likely to be successful for that that particular user based on the machine learning algorithm. The machine learning and modeling server 114 comprises a training module 116 and a prediction and scanning module 118. The machine learning and modeling server 114 forms a neural network (shown in FIG. 3). Training data may past data and success data to be entered to match how a successful a person is in that job based on, for example, salary and longevity. The user data that may be employed is for purposes of comparison are user age range, education, experience, and other user side variable inputs.

The platform server 112 is configured to receive user data from the client device 104 associated that data with the user or group of similarly situated user. The platform server 112 is further configured to provide one or more tasks to be performed by the user and collect resulting data of the tasks performed by the user. The platform server 112 is further configured to calculate a score that indicates a likelihood of receiving an offer for an employment position, based on a combination of the user data, task result data and results of the training data from machine learning algorithms. The platform server 112 is further configured to provide additional tasks via Q&A database 120 based on previous scores. The user data may comprise demographic information, health history, skills, experience, education, aptitudes/interests, social needs, and existing benefits. Each variable may have an individual user score and a group score based on training data. The platform server 112 is further configured to provide a user the chance of getting a job in each field based on the data received at the server and while allowing for manual tuning of the module by a managing user.

The platform server 112 is further configured to integrate artificial intelligence to learn and provide tasks to the user for career consulting and management services. The platform server 112 is further configured to create a weekly point system to measure degree of user's activities to receiving the offer for the employment position. The platform server 112 is further configured to correlate user data and result data with job landing success rate and to correlate user data and result data with job landing success rate, commonalities and probabilities.

Still referring to FIG. 1, the platform server 112 is further configured to mine navigation activity to measure how long users are taking with the certain tools and provides data as to how users are navigating the underlaying webpage or UI. The platform server 112 is further configured to optimize a resume by comparing resume and specific job ads and helps optimize getting past ATS systems via key word matches. The platform server 112 is further configured to compares resume and specific job ads and helps optimize job searches with AI to help address spelling, seniority, concept, jargon, acronym and location issues.

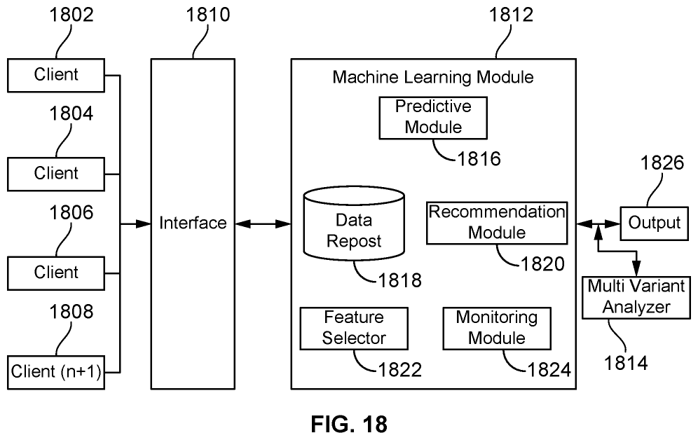

The data routing scheme, which is shown more particularly in FIG. 2, utilizes a plurality of servers each having RAM and/or hard disk storage. As shown in FIG. 1, the user device is in communication with a proxy server 102 via a network. The proxy server acts as intermediary as a hub through user or server requests. The web server 108 is further provided to process incoming network requests over HTTP and several other related protocols. The platform server 112 is in communication with each of the other servers and comprises the protocol for the platform. The virtual server 110 embodies web hosting that shares hardware and software resources with other operating systems (OS) to provide faster resource control. The virtual server 110 is communication with machine learning and modeling module 114. In operation, large amounts of user data are funneled from user devices 104 (n+1) and client database 122 (or data repository shown in FIG. 18) and ran through a proxy server 102 to the platform server 112. The data then is sent to the virtual server for sorting and parsing and is then sent to the machine learning module 114. A loop is created between the machine learning modules 114 and virtual server 110 to continuously train nodes on a neural network (machine learning), or on other embodiments, execute a random forest algorithm to run the predictive analyses on the data to suggest or provide probabilities of success at finding employments based on the data provided.

FIG. 2 illustrates a block diagram 200 showing components and connections between the components of the automated system for providing career consulting and management services and the data routing and parsing schema according to an embodiment of the present platform. User or client is enabled to input data via client UI 208, which is sent to processor 212 through input/output 204. Management module 206 receive data via management UI 210. Management module 206 allows a manager to tune the system based on in person interaction with the user and the user's desires. This allows a combination of subjective and objective evidence to get the best job for the user. Further, because of the large amount of data, a centralized RAM 214 (or non-persistent storage) is provided. A combination of machine learning, client data and Q&A data are stored in RAM 214, sifted, and only the relevant information is sent back to the database for permanent persisted storage. The data also stored in machine learning storage 216 for use by the training module 116. Information that is relevant is determined by a combination of the machine learning module 114, machine learning storage 216 and the management UI 210, the latter of which allows a user at management UI 210 to select certain data sets to include—generally those data sets that are subjective as it pertains to the specific user. In this way, the RAM 214 acts as the hub of a data wheel, with each input and output acting as a spoke. The RAM 214 is in communication with machine leaning storage 216, Q&A database 120, client database 122 and training module 116. The RAM 214 is in communication with the processor 212. The processor is in communication with the I/O 204 and the management module 206. In operation, the RAM 214 receives all data from the I/O. The RAM is configured to hold all the data as non-persisted data and send share the data with a parsing module 220 of the processor 212. Parsing the data comprises reviewing population data sets and/or user datasets and using only those data set considered relevant to the user. Once the decision is made datasets that are relevant to the user. Those datasets that are relevant are output back to non-persisted storage and are continued to be used by the machine learning training module 116. When the RAM 214 is full, the processor will shut the RAM 214 on and off to empty the RAM 214, acting as in internal “restart” so the RAM 214 can store and process additional data continuously.

FIG. 3 illustrates a structure 300 of machine learning neural network nodes 304 together with scoring overlay 302, according to an embodiment of the present platform. Inputs comprise answer to answers to questions from the users, training data population scores and the like. The neural network as shown is a multi-layered network of neurons that are uses classifying inputs and making with two hidden layers. In operation, inputs 306 may be any input variable discussed above. Hidden layer 308 may estimate the slope parameter of a logistic regression, and the tells the system by how much the Log_Odds change as 306 changes. Each of the inputs are connected to each node of hidden layer. The second hidden layer 310 may the bias or the intercept term from regression. The neurons at 310 or 308 may comprise a sigmoid activation function to go from log-odds to probability at the output 312 by applying the sigmoid function to the quantity at hidden layer 310.

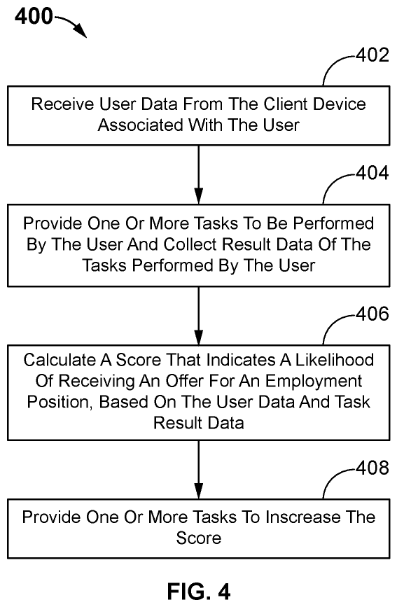

FIG. 4 illustrates a method 400 for providing data routing and data parsing on a career consulting and management services platform which incorporates a client device, and a server in communication with the client device, a memory to store instructions and data, and a processor coupled with the memory to process the stored instructions, according to an embodiment of the present platform.

At step 402, the user inputs user data via the client device associated with the user. At step 404, one or more tasks are sent to the user and result data of the tasks performed by the user is stored at the memory of the server. At step 406, the system utilizes the RAM a neural network calculating a score that indicates a likelihood of receiving an offer for an employment position based on the user data and task result data. At step 408, one or more tasks are provided to the user to increase the score and increase the probability of landing on the desired employment, at which point the method is repeated.

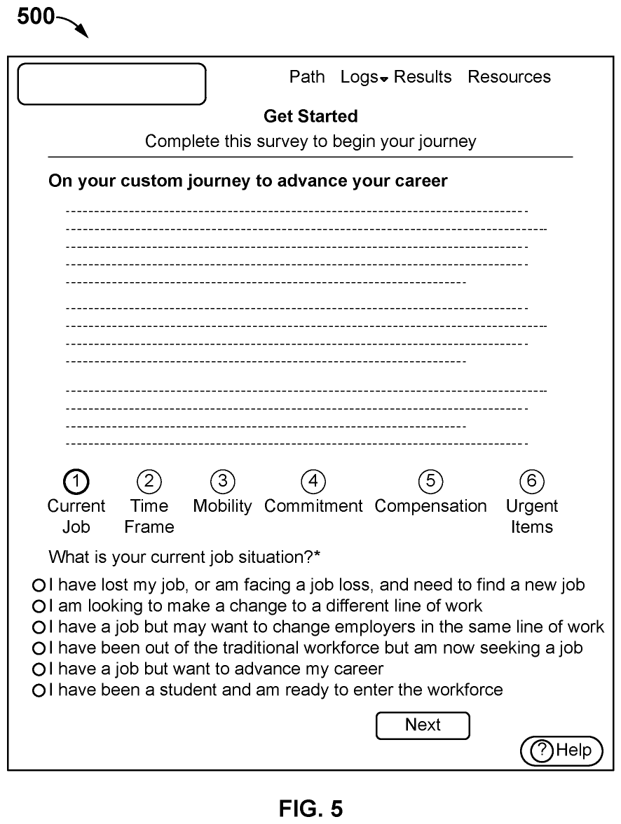

FIG. 5 illustrates an exemplary screenshot 500 of a user interface of an initial survey to be completed by the user, according to an embodiment of the present platform. It should be noted that the exemplary screenshots herein are not exclusive, meaning that other information and data gathering exercises and tasks may be employed. The survey facilitates to collect user information related to categories, including, but not limited to, current job, time frame, mobility, commitment, compensation and urgent times. The user information is collected by one or more methods, including, but not limited to, providing multiple choice questions.

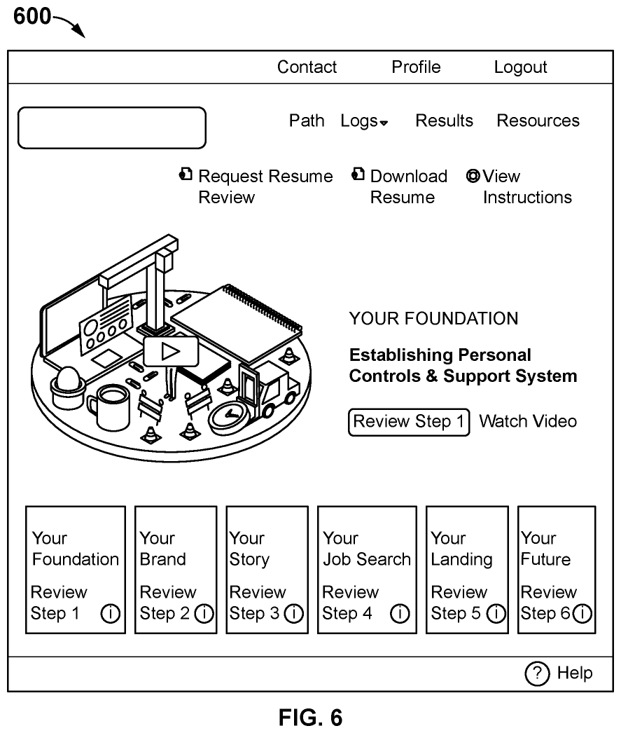

FIG. 6 illustrates a screenshot 600 of a user interface of a survey to be completed by the user to identify suitable employment position, according to an embodiment of the present platform. The survey facilitates to collect information related to user's foundation, brand, story, job search, landing and future.

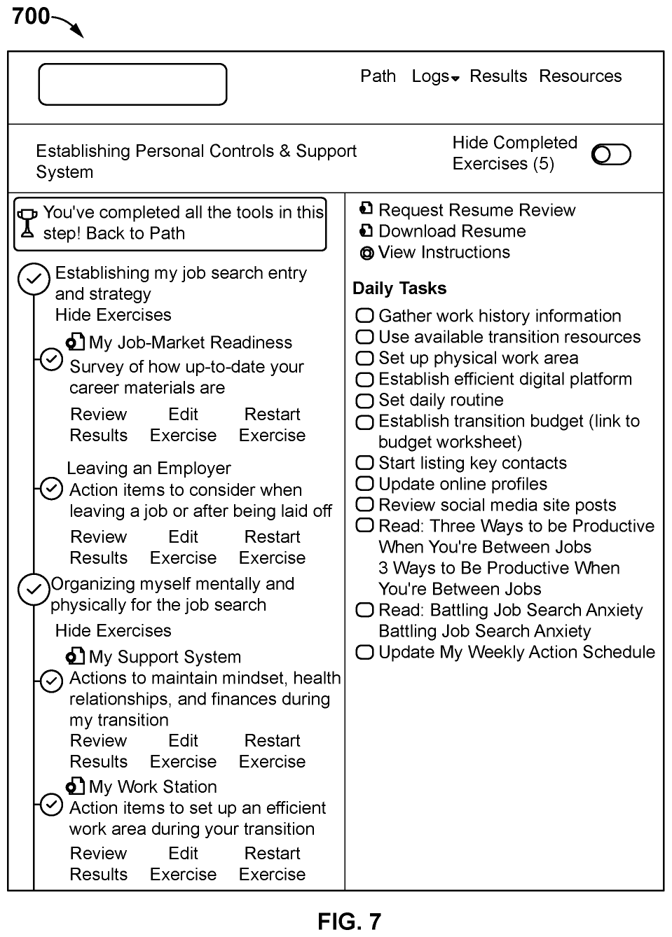

FIG. 7 illustrates a screenshot 700 of a user interface displaying one or more exercises/tasks to be performed by the user, according to an embodiment of the present platform. The exercise includes, but not limited to, establishing job search entry and strategy, and organizing user's mental and physical state for job search. Each exercise includes one or more sub-category of exercises. In one example, exercise related to establishment of job search entry and strategy includes the following sub-category of exercises including, but not limited to, survey of up-to-date career materials, survey of action items to consider when leaving a job or after being laid off. In another example, exercise related to organizing user's mental and physical state for job search includes the following sub-category of exercises including, but not limited to, action to maintain mindset, health relationships, finances during transition, action to setup an efficient work area during transition, and actions to maintain time during transition.

Each exercise and sub-category of exercise provided with one or more options including, but not limited to, review results, edit exercises, restart exercises. These options facilitate the user to review, edit or restart each exercise or each sub-category of exercise. One or more daily tasks also provided to the user, which facilitates to gather work history information, use available transition resources, set up physical work area, establish efficient digital platform, set up daily routine, establish transition budget, identify key contacts, update online profiles, review social media site posts, reading one or more job related articles, and update weekly action schedule.

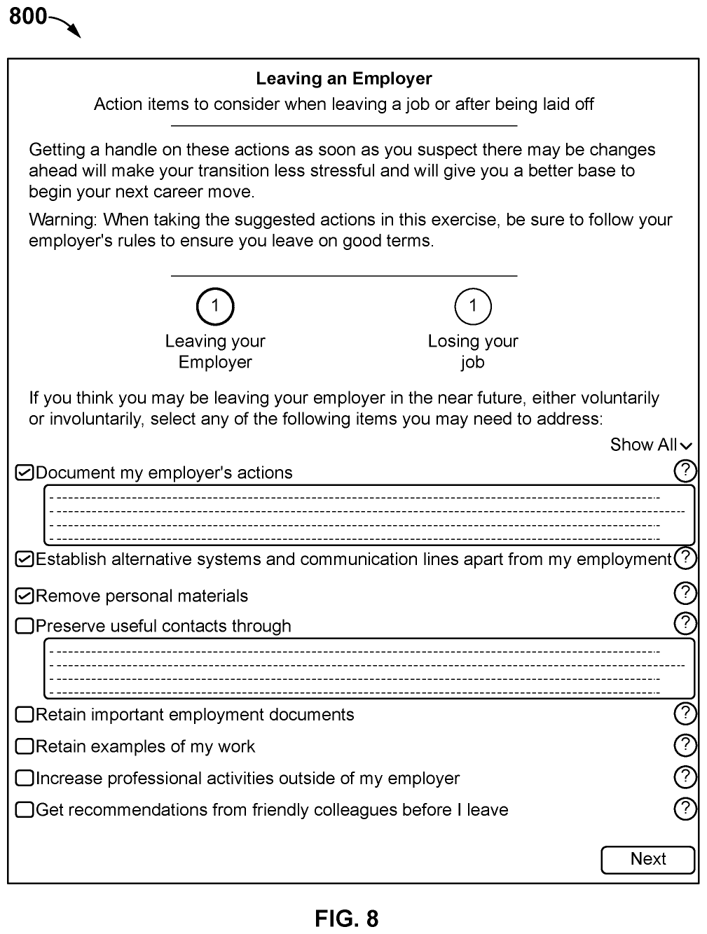

FIG. 8 illustrates a screenshot 800 of a user interface displaying an exercise that facilitates the user to handle a situation on leaving the employer, according to an embodiment of the present platform. The exercise involves a list of activities to be considered on leaving the employer, which includes, but is not limited to, documenting employers' actions, establishing alternative system and communication lines apart from employment, removing personal materials, preserving contacts, retaining important employment documents and increasing professional activities outside the employer.

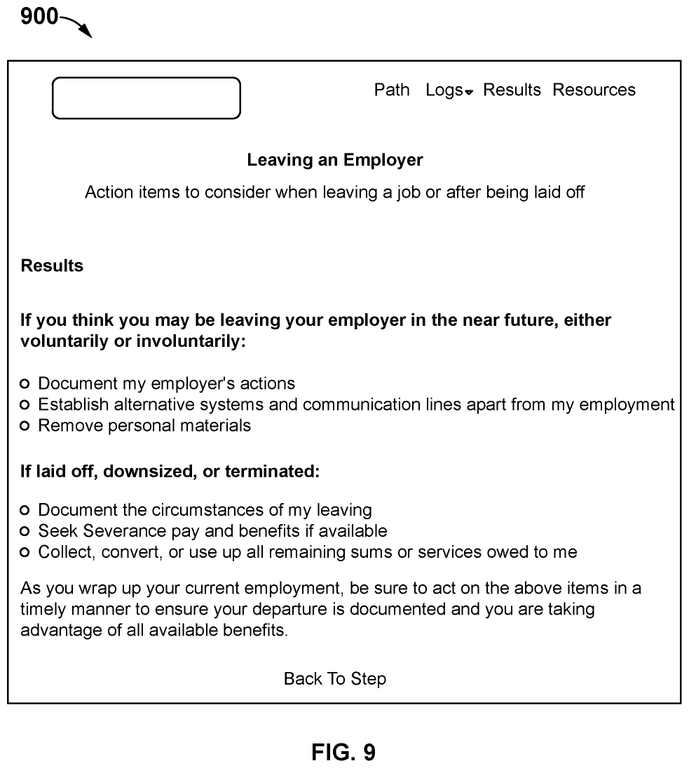

FIG. 9 illustrates a screenshot 900 of a user interface displaying result of the exercise that facilitates the user to handle situation on leaving the employer, according to an embodiment of the present platform. For example, if the user has selected items such as document employers' action, establish establishing alternative system and communication lines apart from employment, removing personal materials during the exercise that facilitates the user to handle situation on leaving the employer, the summary of items/actions to be performed on leaving the employer is displayed to the user as a result of the exercise.

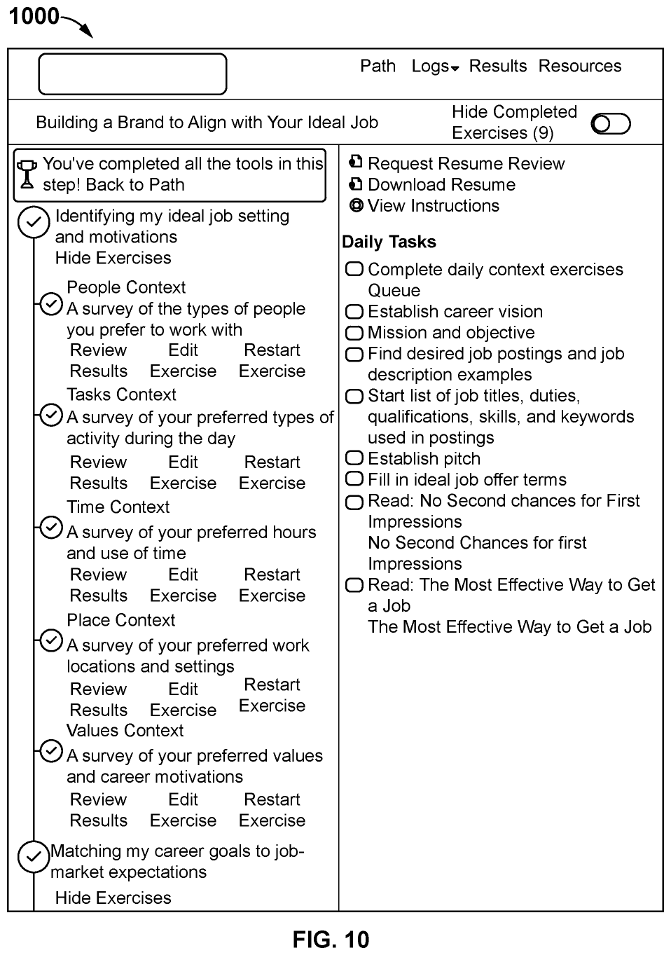

FIG. 10 illustrates a screenshot 1000 of a user interface displaying one or more activities to be performed by the user to build a brand to align with user's ideal job, according to an embodiment of the present platform. The exercise includes, but is not limited to, identifying ideal job settings and motivations and matching user's career goals to job market expectations. Each exercise includes one or more sub-category of exercises.

In one example, exercise related to identification of ideal job settings and motivations includes the following sub-category of exercises including, but is not limited to, a survey of types of people preferred the user to work together, a survey of preferred types of activity during the day, a survey of preferred work time, a survey of preferred work location and setting and a survey of preferred values and career motivations. In another example, exercise related to matching user's career goals to job market expectations includes the following sub-category of exercises including, but not limited to, composing vision, mission, objective of user's career and job search, constructing a detailed set of terms for a user's ideal job, determining what qualities an employer are looking for in a candidate in user's line of work.

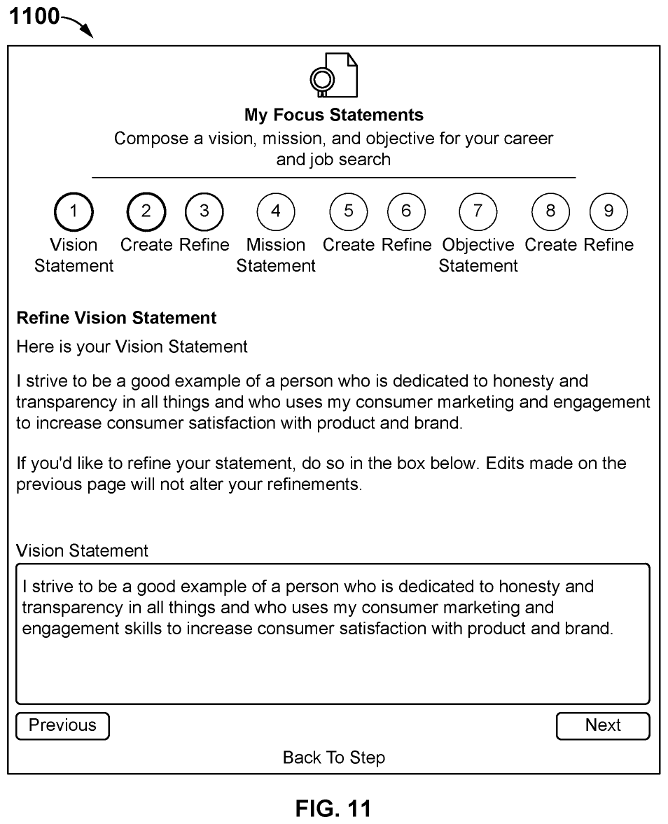

FIG. 11 illustrates a screenshot 1100 of a user interface of survey to obtain vision related to user's career and job search, according to an embodiment of the present platform. The survey prompts the user to create and refine user's vision, mission and objective statement.

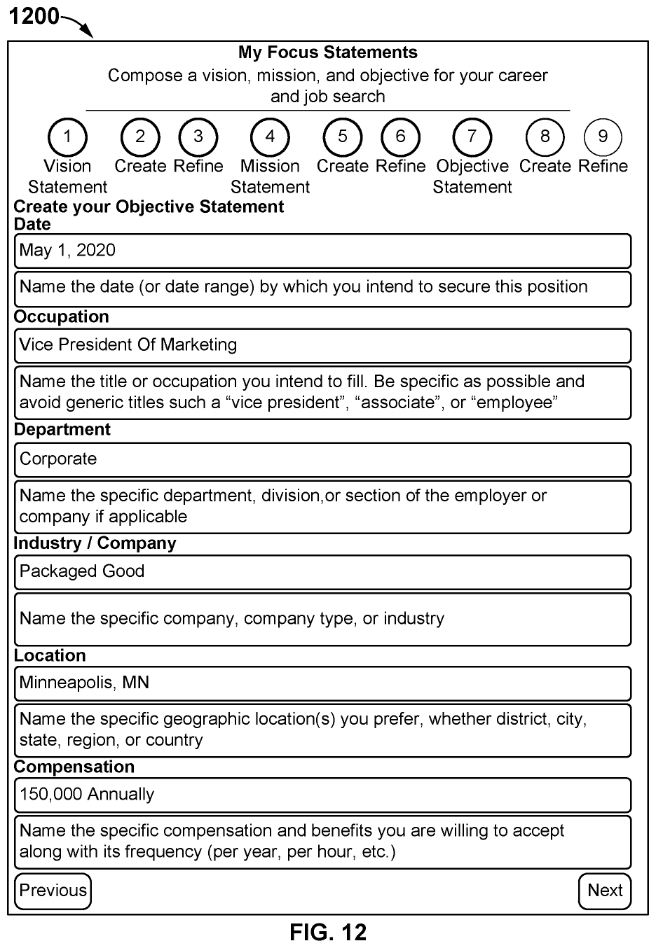

FIG. 12 illustrates a screenshot 1200 of a user interface of survey to obtain objective data related to user's career and job search, according to an embodiment of the present platform.

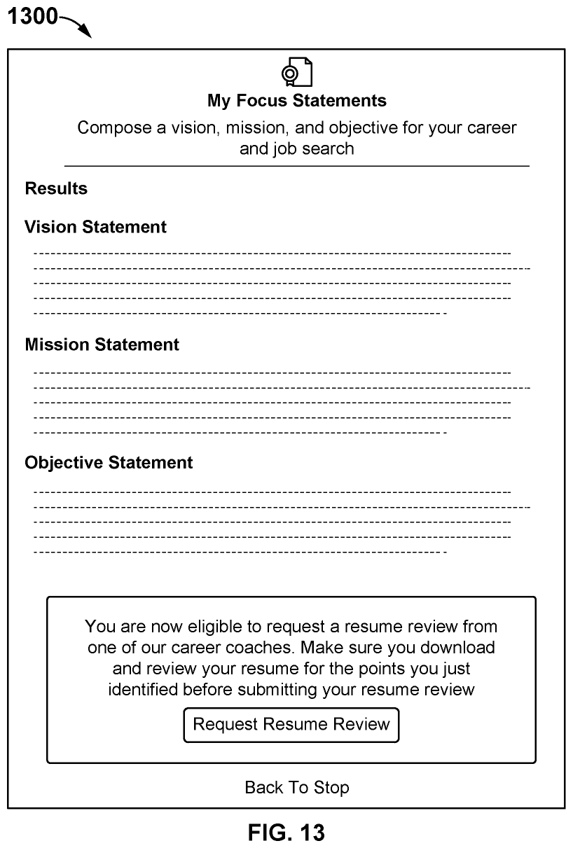

FIG. 13 illustrates a screenshot 1300 of a user interface displaying results of survey of FIG. 11 and FIG. 12, according to an embodiment of the present platform. Based on the data provided by the user during the survey, a summary of user's vision statement, mission statement and objective statement are generated and displayed to the user. These statements are intended to enable the user to think through main career direction and goals throughout their career or job search.

In one embodiment, the system further provides a user interface to assist in developing core materials via one or more exercise, which includes, but is not limited to, organizing work history and accomplishments, creating and customizing resume. Utilizing job search portal such as LinkedIn. Utilization of job portal involves creation of basic profile, using the job portal for job search or to expand the professional network of the user.

In one example, exercise related to organizing work history and accomplishments includes the following sub-category of exercises including, but is not limited to, constructing a complete history of user's experience, education and other offer, listing and describing significant work accomplishments. In another example, exercise related to resume creation includes the following sub-category of exercise, including, but not limited to, composing key phrasing and key skills description pointing to the job which the user is applying, organizing resume to showcase key accomplishments, preparing resume checklist and creating cover letter.

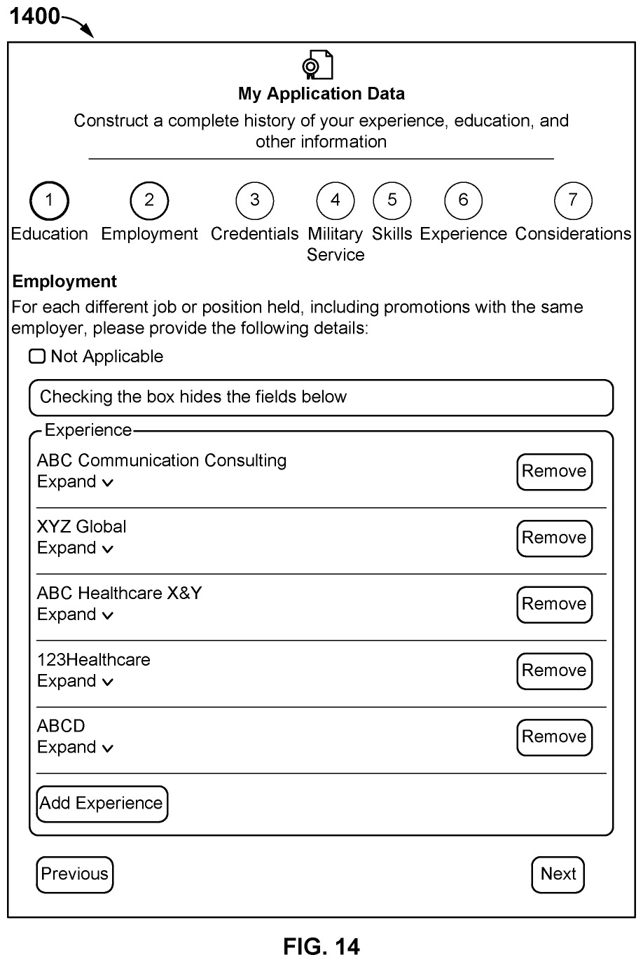

FIG. 14 illustrates a screenshot 1400 of a user interface for constructing a history of your experience, education and other user related information, according to an embodiment of the present platform. The user needs to input a category of exercises, which is related to education, employment, credentials, military service, skills, experience and considerations.

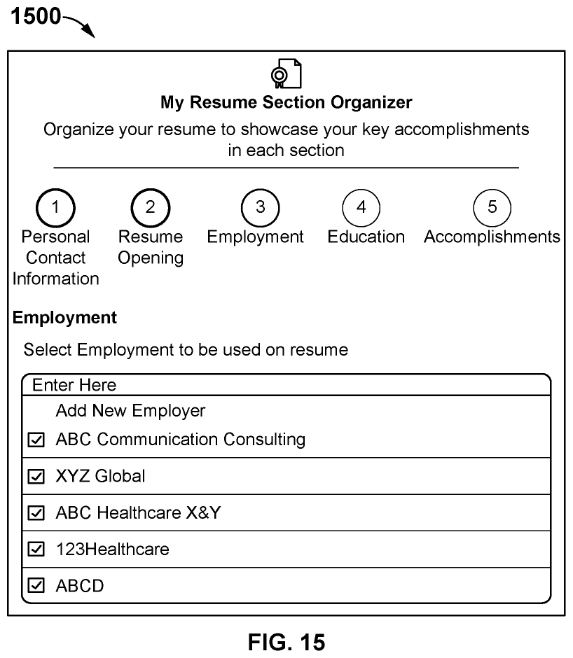

FIG. 15 illustrates a screenshot 1500 of a user interface for organizing user's resume to showcase user's key accomplishments, according to an embodiment of the present platform. The user needs to provide information of the displayed categories such as personal information, resume opening, employment, education and accomplishments. On successful completion of tasks, exercises or other activities, the user can download the generated resume. The user can also request for one or more career coaches to review the generated resume. On requesting a review, the user's resume submitted for review by the career coaches selected by the user. On completion of review, feedback of career coach is sent to the user.

In one embodiment, the system further provides a user interface to assist user to network with target employers and contacts. The system enables to identify and pursue target employers by providing one or more tasks such as researching to generate target employers, creating a target employer list, finding target employers for network approach and follow up and tracking job applications. One or more daily tasks also provided to the user, which includes: updating target employer list; updating target contact list daily; track approach and follow up activity daily; tracking application and interview process; filling in target employer details prior to an interview; reaching out to five networking contacts every day, and reading one or more career related articles.

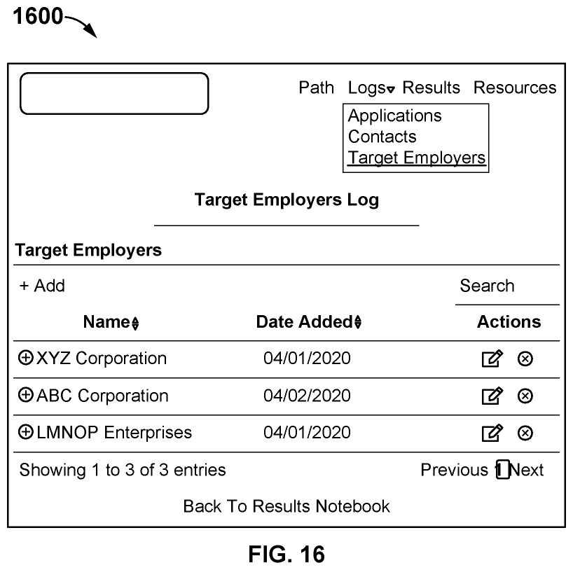

FIG. 16 illustrates a screenshot 1600 of a user interface displaying target employers log selected by the user, according to an embodiment of the present platform.

In one embodiment, the system further provides a user interface that comprises one or more exercise/task to aid in interviewing and negotiating an offer. The task includes preparing and winning the job interview, preparing a comprehensive picture of an employer before an interview, preparing interview prep checklist and preparing offer and negotiation checklist. One or more daily tasks also provided to the user, which includes: preparing for interview testing, knowing work history and practice telling successes and accomplishment stories, knowing goals, requirements and preferences, researching the employer, read and read of job description to understand the requirements, research the interviewer, preparing a closing and offer strategy and reading job related articles. In one embodiment, the system further provides a user interface that comprises one or more tasks to assist ongoing career assessments along with one or more daily tasks.

The tasks include, but is not limiting to, evaluating current job, grading employer's performance, suggest action items to improve current job to advance in user's career. One or more daily task includes but not limited, monitoring job satisfaction, monitoring employer status, practicing tactics for advancement, evaluating job market readiness once every three months and reading career related articles.

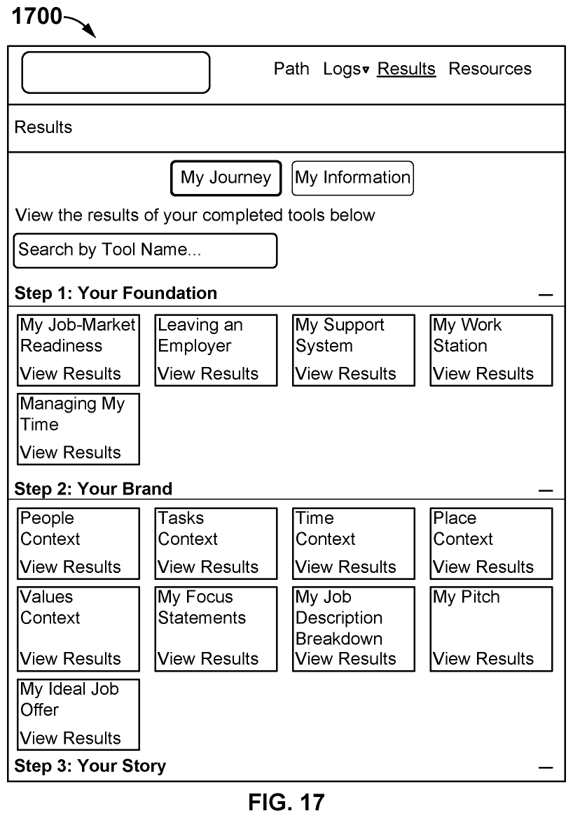

FIG. 17 illustrates a screenshot 1700 of a user interface displaying user's complete career journey, according to an embodiment of the present platform.

Now with reference to FIG. 18, an AI or machine learning routing scheme that combines machine learning with multivariate analyzing techniques for a jobseeker automated platform is shown. In operation, clients 1802, 1804, 1806, and 1808 (n+1) are shown. The client devices allow the user to complete one or more tasks provided to the user, which includes, but is not limited to, filling questionnaires and answers multiple choice questions that reside on Q&A database. Further, the client devices 1802, 1804, 1806, and 1808 allow a user to input data as to the outcome of their job search, the type of job received, the salary, and the like.

A user interface 1810 is provided either locally or over a data network. The interface 1810 is configured to receive inputs from clients and to provide results to the clients. The interface 1810 may provide communication to a machine learning module 1812 to clients 1802-1810, such as a wireless network, API, a hardware command interface, or the like, over which clients 1802-1808 may make requests and receive inputs and outputs. The interface 1810 allows database/data repository 1818 of the machine learning module 1812 to collect information, response data and inputs from the clients 1802-1810.

The machine learning module 1812 comprises a multivariate analyzer 1814, a predictive analyzer module 1816, the data repository 1818, a data set selector module 1822, a correlation module 1824, and a recommendation module 1820. The modules work together to provide the output 1826. In operation, a loop is created between the modules to continuously train nodes on a neural network or on other embodiments, execute a random forest algorithm to run the predictive analyses on the data to suggest to users if they perform steps A, B, and C, they shall have a probability of X, Y, and Z at procuring employment in a specific field.

The multivariate analyzing module 1812 is in communication with data repository 1818 and predictive analyzer 1816. The multivariate analyzer 1812 may comprise a generalized linear model (GLM), which is a flexible generalization of ordinary linear regression that allows for response variables that have error distribution models other than a normal distribution. Further, in embodiments, it allows the platform to derive predictions for countless number of variables and affords the platform the flexibility to model different distributions instances of exercise completion and how it relates to gainful employment. Further, it allows the platform to choose the functional form (such as identity, log, or power function) of the relationship between the employment success prediction being modeled and the relativity variables under consideration. Additionally, the platform is able to assess whether the estimated probability relativities are signal or noise using a prolific number of model diagnostic measures such as standard errors, Chi-Squared Statistics, Archaic Information Criterion (AIC), F-statistics, and many others.

In embodiments, the GLM generalizes linear regression by allowing the linear model to be related to the response variable via a link function and by allowing the magnitude of the variance of each measurement to be a function of its predicted value. In operation, the multivariate analyzing module 1812 receives data from clients (e.g., job seekers) and from the platform (e.g., the activities and exercises they completed on the platform), and further, uses predictive modeling module to correlate activity data with aggregated data of successful job seekers. This data can be used by the machine learning module. Further, the GLM module sees data overlap and removes bias, and deconstructs the effect the different features actual have on likelihood of success with certain variables contributes to the likelihood of finding employment together with predictive analyzer 1816. In embodiments, this multivariate module may be utilized alone to make predictions on employment based on user data.

Predictive analyzer 1816 works with the GLM to determines one or more features, instances of features, or the like that correlate with higher confidence metrics (e.g. that are most effective in predicting results with high confidence). The predictive analyzer 1816 may cooperate with, be integrated with, or otherwise work in concert with the feature selector 1822 to determine one or more features, instances of features, or the like that correlate with higher confidence metrics.

The data set selector 1822 is also communication with data repository 1818 and the other modules in the system. The data selector module 1822, in one embodiment, determines which features of initialization data to use in the machine learning module, and in the associated learned functions, and/or which data of the initialization data to exclude from the machine learning module, and from the associated learned functions. Further, an operator graphical user interface may be employed so that an operator can choose which of the data sets or outputs to be used.

Monitoring module 1824 is in communication with the data repository 1818 and other modules to constantly monitor user activity and user that activity to influence what activities a user shall be provided with that will increase the user's success in finding employment. In this way, the machine learning module constantly updates the model to provide superior results to users as the data sets grow and more users are on the system.

In operation, the platform shown in FIG. 18 uses the data collected from users in FIGS. 5-17 to provide a model that is used on future users to instruct user's which activities or steps to perform to increase their likelihood of receiving employment. In operation the a predictive analyzer module analyzes which of the at least one tasks correlates with a confidence metric. The confidence metric predicts employment for a user, and further, outputs the confidence metric. The multivariate analyzing module utilizes output confidence metric to perform predictive modeling to correlate outputs associated with the at least one task with confidence data to output a quantification of chance of success at finding the employment.

While the present system has been described in connection with what are presently considered to be the most practical and preferred embodiments, it is to be understood that the present system is not limited to these herein disclosed embodiments. Rather, the present system is intended to cover all of the various modifications and equivalent arrangements included within the spirit and scope of the appended claims.

Although specific features of various embodiments of the system may be shown in some drawings and not in others, this is for convenience only. In accordance with the principles of the system, the feature(s) of one drawing may be combined with any or all of the features in any of the other drawings. The words “including”, “comprising”, “having”, and “with” as used herein are to be interpreted broadly and comprehensively and are not limited to any physical interconnection. Moreover, any embodiments disclosed herein are not to be interpreted as the only possible embodiments. Rather, modifications and other embodiments are intended to be included within the scope of the appended claims.

We claim:

1. A system for forecasting a chance of success of a user locating employment, assisting the user to become employed, or both, the system comprising:
at least one client device associated with a user, wherein the at least one client device comprises a graphical user interface (GUI) that allows a user to complete at least one task;
a network interface for receiving an input from the GUI, and sending an output to a server, wherein the output is associated with the at least one task;
a machine learning module residing on the server and in communication with the network, wherein the machine learning module comprises:
a data repository for collecting the outputs associated with the at least one task and to associate the outputs to the at least one user, a group of users, or both;
a monitoring module to monitor user inputs and outputs and update the machine learning module thereby providing a loop; and
a predictive analyzer module to analyze which of the at least one tasks correlates with a confidence metric, wherein the confidence metric predicts employment for a user, and further, to output the confidence metric; and
a multivariate analyzing module in communication with the machine learning module and the data repository, wherein the multivariate analyzing module utilizes output confidence metric from the data repository to perform predictive modeling to correlate outputs associated with the at least one task with confidence data to output a quantification of chance of success at finding the employment.

2. The system of claim 1, wherein the multivariate analyzing module further outputs additional suggested tasks to increase a probability of the user locating employment.

3. The system of claim 1, wherein the multivariate analyzing module uses generalized linear model (GLM) to derive predictions for the outputs, and to allow the multivariate analyzing module to choose a functional form of a relationship between user employment success prediction and the output under consideration whilst removing a statistical bias.

4. The system of claim 1, wherein the machine learning module further comprises:
a data set selector module in communication with the data repository, wherein the data selector module determines which outputs to use in the machine learning module and which outputs to exclude from the machine learning module, and further allows an operator to choose outputs to be used using an operator graphical user interface.

5. The system of claim 1, wherein the at least one tasks comprises, using the user UI, filling out questionnaires provided by the server, answering multiple choice questions provided by the server, inputting an ideal a type of type of employment, a desired salary, or any combination thereof.

6. The system of claim 1, wherein the machine learning module comprises a neural network having a plurality of nodes and at least two hidden layers, wherein the loop is created to continuously train nodes on the neural network.

7. A non-transitory computer-readable medium for storing instructions that, when executed on one or more processors, cause the one or more processors to:
generate, for display on a client device graphical user interface (GUI) associated with at least one user, at least one task to be completed by the user;
receive an output from the client device GUI, wherein the output is associated with the at least one task completed by the user;
compile, at a data repository, the outputs;
generate a confidence metric using a machine learning module;
determine which of the at least one tasks correlates with the confidence metric that relates to predicting employment for the user;
monitor the user inputs and outputs and update the machine learning module thereby providing a loop; and
perform multivariate analysis utilizes the output confidence metric and the outputs to perform predictive modeling to correlate monitored data with confidence data;
output a quantification of chance of success of the user at finding the employment.

8. The non-transitory computer-readable medium of claim 7, further comprising, when the processor is executed, output additional suggested task to increase the chance the user locates employment.

9. The non-transitory computer-readable medium of claim 7, wherein the multivariate analyzing module uses generalized linear model (GLM) to derive predictions for the outputs, and to allows the multivariate analyzing module to choose a functional form of a relationship between user employment success prediction and output under consideration whilst removing bias.

10. The non-transitory computer-readable medium of claim 7, wherein the machine learning module further comprises:
a data set selector module in communication with the data repository, wherein the data selector module determines which outputs to use in the machine learning module and which outputs to exclude from the machine learning module, and further allows an operator to choose outputs to be used using an operator graphical user interface;
a recommendation module configured to output the confidence metric, and to output recommended additional tasks.

11. The non-transitory computer-readable medium of claim 7, wherein the at least one tasks comprises, using the user UI, filling out questionnaires provided by the server, answering multiple choice questions provided by the server, inputting an ideal a type of type of employment, a desired salary, or any combination thereof.

12. The non-transitory computer-readable medium of claim 7, wherein the machine learning comprises a neural network having a plurality of nodes and at least two hidden layers, wherein the loop is created to continuously train nodes on the neural network.

13. A method for providing career consulting and management services incorporated in a system including a client device, and a server in communication with the client device, wherein the server comprises a memory to store instructions and a processor coupled with the memory to process the stored instructions, the method comprising the steps of:
generating, for display on a client device graphical user interface (GUI) associated with at least one user, at least one task to be completed by the user;
receiving a user output from the client device GUI, wherein the output is associated with the at least one task completed by the user;
compiling, at a data repository, the user outputs;
generating a confidence metric using a machine learning module;
determining which of the at least one tasks correlates with the confidence metric that relates to predicting employment for the user;
monitoring the user inputs and outputs and update the machine learning module thereby providing a loop;
and
performing multivariate analysis utilizing the output confidence metric and the compiled user output data to perform predictive modeling to correlate monitored data with confidence data;
outputting a quantification of chance of success of the user at finding the employment.

14. The method of claim 13, further comprising outputting additional suggested task to increase the chance the user locates employment.

15. The method of claim 13, wherein the multivariate analyzing module uses generalized linear model (GLM) to derive predictions for the outputs, and to allow the multivariate analyzing module to choose a functional form of a relationship between user employment success prediction and output under consideration whilst removing statistical bias.

16. The method of claim 13, wherein the machine learning module further comprises:
a data set selector module in communication with the data repository, wherein the data selector module determines which outputs to use in the machine learning module and which outputs to exclude from the machine learning module, and further allows an operator to choose outputs to be used using an operator graphical user interface;
a recommendation module configured to output the confidence metric, and to output recommended additional tasks.

17. The method of claim 13, wherein the at least one tasks comprises, using the user UI, filling out questionnaires provided by the server, answering multiple choice questions provided by the server, inputting an ideal a type of employment, a desired salary, or any combination thereof.

18. The method of claim 13, wherein the machine learning comprises a neural network having a plurality of nodes and at least two hidden layers, wherein the loop is created to continuously train nodes on the neural network.

19. The method of claim 13, further comprising the step of correlating, at the server, user data and result data with job landing success rate.

20. The method of claim 14, further comprising the step of automatically generating tasks for a user at a question and answer database.
